(19) United States
(12) Patent Application Publication
(10) Pub. No.: US 2011/0063503 A1
(43) Pub. Date: Mar. 17, 2011

(54) SYNCHRONIZING SECONDARY CONTENT TO A MULTIMEDIA PRESENTATION

(76) Inventors: STEVEN M. BRAND, Weston, MA (US); Andrew Gilbert, Marshfield, VT (US)

(21) Appl. No.: 12/830,655

(22) Filed: Jul. 6, 2010

Related U.S. Application Data
(60) Provisional application No. 61/223,203, filed on Jul. 6, 2009.

(51) Int. Cl. H04N 5/04

(52) U.S. Cl. 348/500; 348/E05.009

(57) ABSTRACT

In various embodiments, secondary content synchronized to a multimedia presentation is delivered. An audio signal is sampled with a local application and transmitted to a remote server. The remote server determines secondary content associated with the audio sample and transmits the secondary content to the local application for display thereat.

### CROSS-REFERENCE TO RELATED APPLICATIONS

This application claims priority to and the benefit of U.S. Provisional Patent Application Ser. No. 61/223,203, filed on Jul. 6, 2009, which is hereby incorporated herein by reference in its entirety.

### TECHNICAL FIELD

Embodiments of the invention generally relate to adding content to multimedia presentations and, in particular, to the display of secondary content alongside multimedia presentations.

### BACKGROUND

A multimedia presentation (e.g., a movie, television program, Internet video, music, or the like) may be supplemented with secondary content synchronized to (i.e., timed to correspond to images and/or sound within) the presentation. The secondary content may include, for example, background information on a news story, additional entertainment for a television program, context-dependent advertising, translation services, accessibility aids (e.g., captions), and/or specialized data feeds of financial, scientific, sports, or other statistical information. In addition, the secondary content may provide interactive services such as social interaction between viewers of the presentation or interactivity between a viewer and the presentation itself (with, e.g., a game show). The secondary content may be delivered to all viewers of the presentation or may be tailored to individuals or groups based on preference, end device capability, and/or location.

While there have been a number of attempts to enhance multimedia presentations with secondary content and/or interactive features, a number of challenges have prevented wide adoption. For example, the number and variety of different multimedia content sources (e.g., traditional movie and television studios, individuals, businesses, non-profit organizations, governments, and others) makes synchronizing secondary content with the primary content by, e.g., modifying the primary content or its source signal difficult. Providing secondary content by modifying the source signals of multimedia presentation (i.e., a standards-based approach) would be impractical to initiate, difficult to maintain, and would be constrained to a subset of sources. Such an approach would also be subject to erosion as technology advances; the trend of expanding content sources will continue as new production technology is developed, the cost of production decreases, and the multiplicity of delivery channels increases.

The diversity of available multimedia delivery channels also makes the synchronization of secondary content difficult. For example, a consumer may receive the same multimedia presentation over traditional broadcast television, over cable television, and/or over the Internet (via multimedia channels such as YouTube, Netflix, Hulu, TV network web sites, news services, or other sources). Other multimedia channels include on-demand sources such as personal-video recorders, on-demand cable services, internet streaming and downloads. In addition, a significant portion of movie and TV viewership now occurs via DVD, Blu-Ray, and other pre-recorded sources. Prior-art synchronization solutions rely on specific aspects of these different types of delivery channels and therefore present interoperability burdens when different sources, channels, and/or consumer devices are used. Furthermore, synchronization solutions that modify the broadcast signal or rely on the timing of the broadcast event do not support time-shifted or alternative-channel presentations. Standards-based approaches might help address interoperability but are costly to initiate and manage and are subject to erosion due to new technology and consumer trends.

Examples of prior-art secondary-content synchronization methods include closed captioning, open captioning, and set-top box captioning. Each prior-art method, however, exhibits some or all of the disadvantages described above. Closed-captioned television (“CCTV”), for example, is limited to simple displays of previously encoded text, and its reliance on the source signal for bandwidth limits the amount of transmitted data. Furthermore, CCTV does not support end-user addressability, customization, or interactivity. CCTV is not available on alternative viewing devices such as web browsers, mobile computers, or smartphones, and is not compatible with newer HDMI-based televisions.

Open-captioning content is embedded directly into a source presentation before it is sent over the delivery channel and includes content such as sports score and financial tickers, show promotions, pop-up content supplements, news headlines, advertisements, and the like. Open captioning is intrusive, however, because it is presented to all viewers of the content, regardless of individual user preferences, and requires space within the original broadcast format. It does not allow for end-user content variation and does not support interactivity. The bandwidth of the open-caption secondary content is limited by both the broadcast signal and the format limitations for that content channel and end device. Open captioning may support alternative delivery channels such as DVD, web browsers, or mobile devices.

Set-top boxes may be used to provide secondary content, but addressability is on a household or end-device basis; the individual end-user cannot be addressed. For example, each person viewing a presentation on a television must view the same secondary content displayed on the television. Thus, the supplemental content may be considered welcome by some viewers but intrusive to others, and is also subject to the viewing device's format limitations. The set-top box must be in-line to the viewing experience (i.e., be actively used to display images on a television); the use of a separate personal-video recorder, DVD player, or computer to display images on the television, for example, prohibits the display of secondary content from the set-top box.

None of the prior-art secondary-content delivery systems, therefore, are capable of displaying secondary content that is compatible with any multimedia source and any delivery channel, that is end-user addressable, that is customizable, and that is interactive. A need clearly exists for such a secondary-content delivery system.

### SUMMARY

In general, various aspects of the systems, methods, and apparatus described herein provide customizable, interactive, and individualized secondary content for use with any multimedia source and any delivery channel. In various embodiments, an audio component of a multimedia presentation is used as a reference for synchronizing presentation of secondary content. The multimedia presentation may emanate from any device or application (e.g., a television or computer), and the secondary content may be displayed or played back on the same or a different device (e.g., in a separate window or audio track on the presentation device or on a separate television, computer, or mobile device). Audio signal processing may be used to synchronize a sample of the audio component of the multimedia presentation to the supplemental content. In one embodiment, a secondary device or application acquires samples of the audio component of the primary presentation, and the samples are matched to a reference to synchronize the supplemental content to the primary multimedia content stream. The multimedia presentation may be broadcast television, movies, and/or other mass media audio/visual presentations—indeed, any multimedia content having at least one audio component exhibiting sufficient variance to facilitate synchronization.

In general, in one aspect, a method provides secondary content synchronized to a remotely-experienced multimedia presentation. An audio sample of the multimedia presentation is received from a remote location, and a temporal location of the audio sample within the multimedia presentation is determined. Secondary content based on the temporal location is identified and delivered, synchronized to the multimedia presentation, to the remote location.

In various embodiments, the multimedia presentation (e.g., a live or time-shifted TV program) may be identified based at least in part on the audio sample by comparing the audio sample to a database of audio features. The audio sample may be received from a device located where the multimedia presentation is experienced. The temporal location may be determined based on an analysis of the audio sample.

The multimedia presentation may be analyzed, prior to determining the temporal location, to facilitate locating of the audio sample within the multimedia presentation. Results of the analysis of the multimedia presentation may be stored in an audio features database. Analyzing the multimedia presentation may include indexing and/or feature extraction (e.g., pre-emphasizing audio content of the multimedia presentation, creating frames of samples of audio content of the multimedia presentation, extracting features of audio content of the multimedia presentation in a time domain, and/or extracting features of audio content of the multimedia presentation in a frequency domain).

Determining the temporal location may include matching a pattern in the audio sample with a pattern in the multimedia presentation. The audio sample may be received at a periodic interval, on an ad-hoc basis, or at a request from a user. Identifying secondary content may include querying a database of secondary content with the temporal location, and the secondary content may include live user-generated content and/or stored user-generated content.

In general, in another aspect, a system provides secondary content synchronized to a multimedia presentation. Computer memory stores an audio sample of the multimedia presentation, and an audio-processing module determines a temporal location therein of the audio sample. A content-processing module identifies secondary content based on the temporal location, and a transmitter transmits the secondary content, synchronized to the multimedia presentation, to a remote location.

In various embodiments, the audio-processing module includes a time-indexing module and/or feature-extractor module (which may include a pre-emphasis filter, a window frame-builder module, a time-domain feature extractor, and/or a frequency-domain feature extractor). A secondary-content server may host a database of secondary content that serves the secondary content based on the determined temporal location. The interface module may be hosted on a notebook computer, netbook computer, desktop computer, personal digital assistant, cellular phone, and/or handheld media player. The secondary content may include live user-generated content and/or stored user-generated content.

In another aspect, a method delivers secondary content synchronized to a multimedia presentation to a user. An audio sample is created by sampling an audio portion of the multimedia presentation and transmitted to a remote server. Secondary content, based at least in part on the temporal location of the audio sample in the multimedia presentation, is received synchronized to the multimedia presentation. The secondary content is delivered, via a user interface, to the user.

In various embodiments, delivering the secondary content may include displaying visual data and/or playing back audio data. The audio sample may be varied in length and may be pre-processed (e.g., normalized or initial-feature extracted) prior to transmission. The secondary content may be delivered based a user preference, a location of the user interface, and/or a screen size of the user interface. The secondary content may include live user-generated content and/or stored user-generated content.

In yet another aspect, an article of manufacture includes computer-readable instructions thereon for delivering secondary content, synchronized to a multimedia presentation, to a user. The article of manufacture includes instructions to sample an audio portion of the multimedia presentation, thereby creating an audio sample, and instructions to transmit the audio sample to a remote server. The article of manufacture further includes instructions to receive secondary content based at least in part on the temporal location of the audio sample in the multimedia presentation synchronized to the multimedia presentation, and instructions to deliver the secondary content to the user.

In various embodiments, delivering the secondary content may include one of displaying visual data or playing back audio data. The article of manufacture may further include instructions for pre-processing the audio sample prior to transmission, and pre-processing the audio sample may include normalization and/or initial-feature extraction. The secondary content may be delivered based on a user preference, a location of the user interface, and/or a screen size of the user interface. The secondary content may include live user-generated content and/or stored user-generated content. The article of manufacture may further include instructions for varying the length of the audio sample.

In still another aspect, a method delivers secondary content synchronized to a multimedia presentation to a user. An audio sample is created by sampling an audio portion of the multimedia presentation, and a temporal location of the audio sample within the multimedia presentation is determined. The secondary content is identified based on the temporal location, and the secondary content is delivered to the user via a user interface. In one embodiment, audio features and/or secondary content, each corresponding to the multimedia presentation, are received from a remote location and stored in a local database.

In another aspect, a system provides secondary content synchronized to a multimedia presentation. Computer memory stores an audio sample of the multimedia presentation, and a pre-process module determines a temporal location, within the multimedia presentation, of the audio sample. A user interface delivers secondary content corresponding to the temporal location to a user. In one embodiment, the secondary content is stored in a local database.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 is a block diagram of a system for delivering secondary content synchronized to a multimedia presentation in accordance with an embodiment of the invention;

FIG. 2 is an illustration of an exemplary system for delivering secondary content synchronized to a multimedia presentation in accordance with an embodiment of the invention;

FIG. 3 is an flow chart of a method for delivering the secondary content to a remote location in accordance with an embodiment of the invention;

FIG. 4 is an flow chart of a method for extracting audio features from an multimedia presentation in accordance with an embodiment of the invention; and

FIG. 5 is an flow chart of a method for delivering the secondary content to a user in accordance with an embodiment of the invention.

### DETAILED DESCRIPTION

Described herein are various embodiments of methods and systems for delivering secondary content synchronized to a multimedia presentation. In general, an audio signal is sampled with a local application and transmitted to a remote server. The remote server determines secondary content associated with the audio sample and transmits the secondary content to the local application for display thereat.

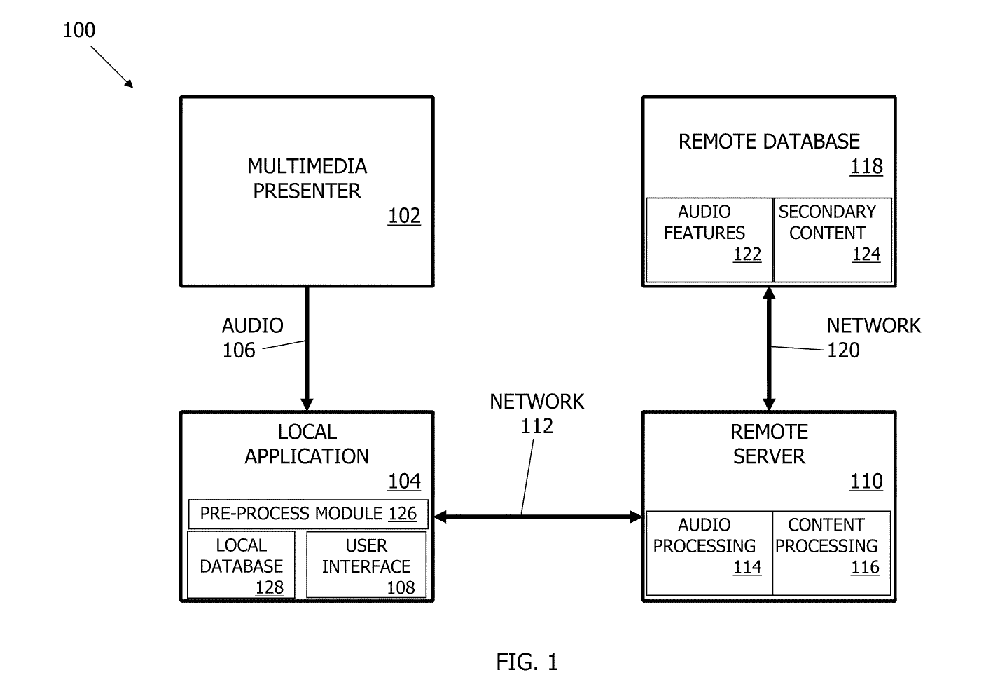

FIG. 1 illustrates a secondary-content delivery system 100 in accordance with an embodiment of the invention. A multimedia presenter 102 plays a multimedia presentation having at least one audio component, and a local application 104 samples the audio component via a sample channel 106. The multimedia presenter 102 may be a television, movie theater, stereo system, computer, projector, portable music player, cellular phone, or any other device capable of presenting the audio component (in addition to any other multimedia components). Alternatively, the multimedia presenter 102 may include live content, such as a play, opera, musical, sporting event, or concert. The local application 104 may be a software program running on a computer (including desktop computers, notebooks, and netbooks), cellular phone, personal digital assistant, portable music player, or any other computing device. In another embodiment, the local application 104 is implemented in firmware and runs on a dedicated, custom device. The local application 104 may be run on the same device as the multimedia presenter 102 or may be run on a device separate from the multimedia presenter 102. The local application 104 communicates with a user interface 108 for receiving input from, and displaying output to, a user. The output from the user interface 108 may include audio and/or visual components.

The local application 104 communicates with a remote server 110 over a network 112. The server 110 may include an audio-processing server 114 and a content-processing server 116, which may be located together on a single device or on separate devices. In one embodiment, the local application 104 transmits the audio sample to the audio-processing server 114. As explained further below, the audio-processing server 114 identifies the type and content of the multimedia presentation based on the audio sample and determines a temporal location of the audio sample within the multimedia presentation. The content-processing server 116 delivers, based on the determined temporal location, secondary content synchronized to the multimedia presentation to the local application 104. The local application 104 may include a pre-process module 126 for performing some or all of the tasks performed by the audio processing server 114 and/or the content processing server 116.

The remote server 110 stores data in a remote database 118, which may be maintained locally to the server 110 or may be located remotely and accessed via a network 120 (which may be the same as the network 112 or a different network). The remote database 118 includes an audio-feature database 122 and/or a secondary-content database 124. The local application 104 may further include a local database 128 for use in addition to, or instead of, the remote database 118, as explained further below.

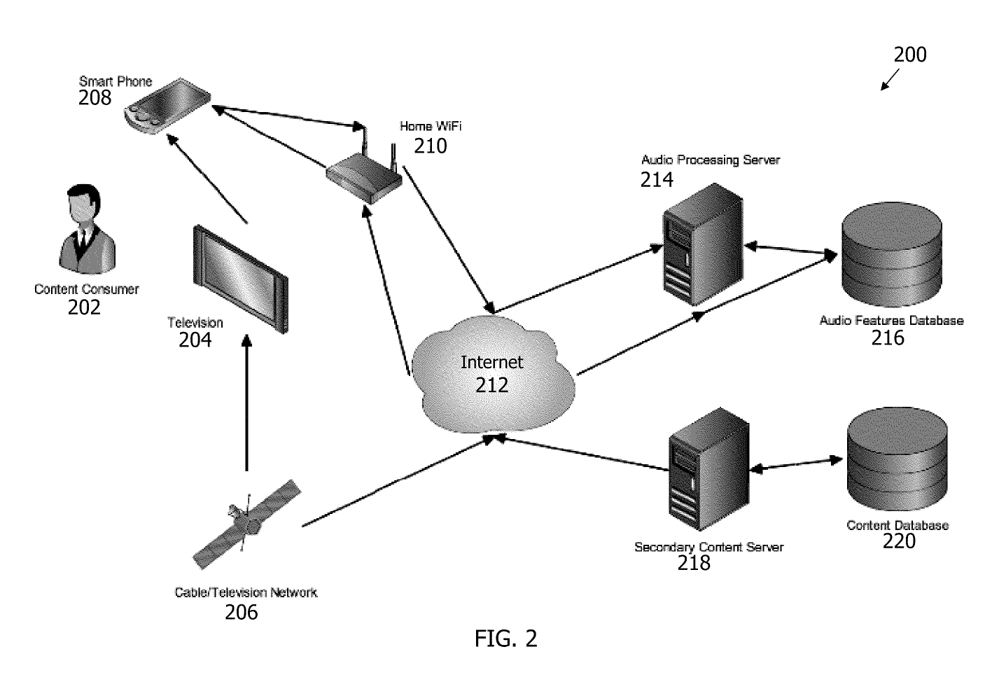

FIG. 2 illustrates an exemplary embodiment 200 of the secondary-content delivery system 100 described above with reference to FIG. 1. A content consumer 202 views a television program on a television 204 broadcast by a cable television network 206. A local application running on the user's smart phone 208 captures an audio sample of the television program and transmits it, via a home WiFi link 210, to an audio-processing server 214 via the Internet 212. The audio-processing server 214 identifies the television program and the temporal location of the audio sample therein by analyzing the audio sample against a data in an audio features database 216. Data in the audio-features database 216 may have been previously computed by, for example, analyzing the television program at an earlier point in time.

Based on the determined temporal location, a secondary-content server 218 identifies secondary content in a content database 220 associated with the television program and transmits the secondary content back to the smart phone 208 via the Internet 212 and home WiFi link 210. The content consumer 202 may then view and/or listen to the secondary content played on the smart phone 208.

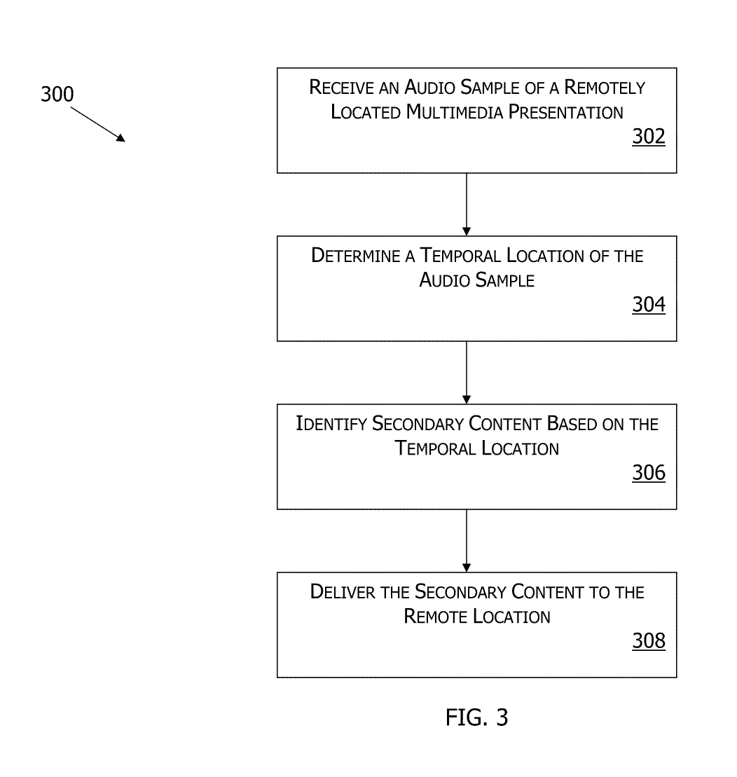

FIG. 3 illustrates an exemplary method 300 for delivering, to a remote location, secondary content synchronized to a multimedia presentation. In summary, an audio sample of the multimedia presentation is received (Step 302). The temporal location of the audio sample within the multimedia presentation is determined (Step 306), and secondary content is identified based on the temporal location (Step 306). The secondary content, synchronized to the multimedia presentation, is delivered to the remote location (Step 308).

In greater detail and with reference also to FIG. 1, in Step 302 a server 110 receives an audio sample of a remotely located multimedia presentation. The audio samples may be received at regular or at varying intervals, depending on the type of multimedia presentation being sampled, among other factors (as explained further below). The audio sample may be stored in local memory, and may be an audio sample of traditional broadcast television, cable television, time-shifted content, DVD, Internet-based content, motion pictures, and/or music.

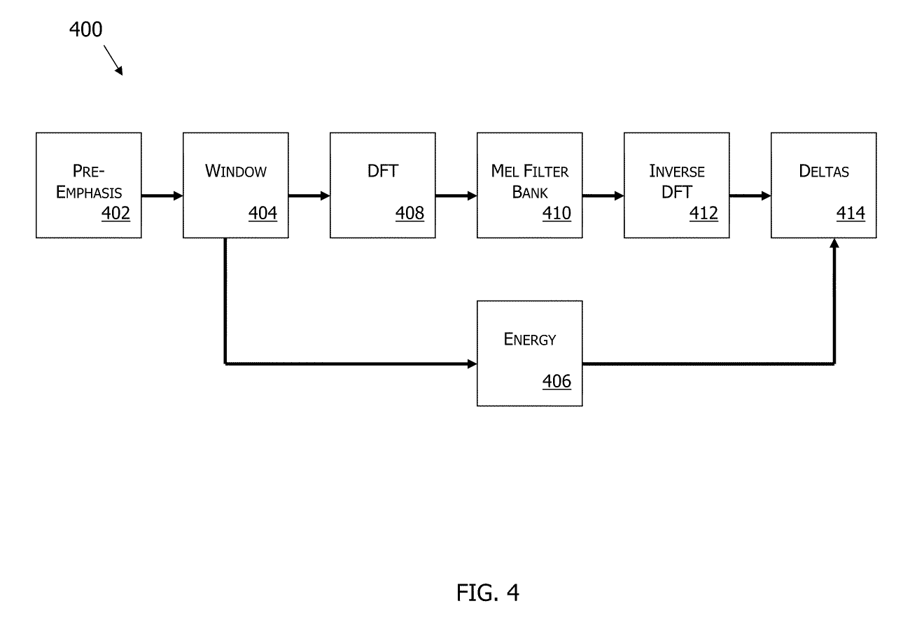

An audio-processing module 114 determines a temporal location of the audio sample within the multimedia presentation (Step 304). In one embodiment, the audio-processing module 114 compares the audio sample against features previously extracted from the multimedia presentation and stored in the audio-features database 122. The audio-features database may be organized to quickly search for and return the temporal location of the audio sample within the multimedia presentation by efficient, probabilistic pattern recognition. In one embodiment, the audio-processing server 214 performs feature extraction and indexing of the audio component of the multimedia presentation, as explained in greater detail below with reference to FIG. 4. The audio-features database 122 may be hosted to facilitate access through a web services call via the Internet, allowing access thereto while minimizing processing, memory, and other resource consumption. The temporal location may be a time index (e.g., a length of time elapsed from the beginning of the multimedia presentation). Suitable feature-extraction and pattern-recognition routines are conventional and readily implemented without undue experimentation.

In one embodiment, the identity of the multimedia presentation is not known to the audio processing module 114, and so the audio-processing module 114 first identifies the presentation before attempting to determine the temporal location of the audio sample within the presentation. For example, the audio-processing module 114 may compare the audio sample against its entire library of audio features. In performing the comparison, the audio-processing module 114 may employ algorithms to narrow the search. For example, based on properties of the audio sample, the audio-processing module 114 may determine if the audio sample represents a live or prerecorded presentation, live events having generally more background noise or other undesirable artifacts typically removed from prerecorded presentations. Individual sounds may be analyzed to determine their origin, and based on their origin (e.g., voice, music, or special effects), the genre of the presentation may be determined and searched first. The audio-processing module 114 may give priority to searching multimedia presentations currently being broadcast on television in the remote location (based on, e.g., the IP address of origin of the received audio sample, user preferences, or other factors).

In one embodiment, a multimedia presentation is analyzed in its entirety and a relevant subset of its audio features is stored prior to receiving the audio sample. In another embodiment, the analysis of the multimedia presentation is done on-the-fly as the audio sample is received. In this embodiment, only the analyzed portion of the multimedia presentation is searched for the temporal location of the audio sample. The on-the-fly analysis of the multimedia presentation (and the transmission of secondary content related thereto, as described below) may be performed in near-real time (i.e., with a delay of less than five, three, or one seconds behind the real-time viewing of the presentation).

The received audio sample may be sufficiently unique that its temporal location (and/or originating multimedia presentation) can be determined solely by searching the audio-features database 122 with only the received audio sample. For example, the audio sample may include a unique word, phrase, sequence of musical notes, or other sound that permits the multimedia presentation to be easily identified. In other embodiments or circumstances, however, the audio sample is insufficient to precisely determine its temporal location (and/or identify its originating multimedia presentation). For example, the audio sample may include noise, common words or phrases, common sounds, or no sounds at all. As a further example, the audio sample may contain part of a television show's opening credit sequence, allowing identification of the show but not of a particular episode. In these cases, further audio samples may be received that identify the multimedia presentation or the samples' place therein. Each received sample may further narrow the possible options, making successive searches simpler and the probability of a correct identification more likely.

If the originating multimedia presentation and/or temporal location of the audio sample cannot be identified with certainty, the audio-processing module 114 may calculate a probability that the correct presentation and/or temporal location has been found. If the calculated probability is greater than a predetermined or user-defined probability, the audio-processing module 114 may select the presentation and/or time index with the highest probability. In another embodiment, the audio-processing module 114 transmits information identifying the one or more presentations and/or temporal locations having the highest probability to the user, and the user selects the proper one.

Once the presentation and/or temporal location have been identified, further received audio samples may be used to confirm that the identified temporal location remains synchronized with the audio samples. For example, a user may pause playback of a DVD or pause playback of live television with a digital-video recorder. The audio-processing module 114 may detect such pauses in the playback of the multimedia presentation and adjust the transmission of secondary content accordingly. In one embodiment, the audio-processing module 114 anticipates the occurrence of regular breaks in the multimedia presentation caused by, e.g., commercials in a television program, and anticipates the pausing of transmission of the secondary content.

Once the temporal location (and/or multimedia presentation) has been identified, a content-processing module 116 determines secondary content based on the temporal location (Step 306). In various embodiments, the determination is also based on the multimedia presentation, user preferences, and/or network bandwidth. The secondary content may be stored in the secondary-content database 124.

The secondary content may include background information on a news story, additional entertainment for a television program, context-dependent advertising, translation services, accessibility aids (e.g., captions), and/or specialized data feeds of financial, scientific, sports, or other statistical information. For example, if the multimedia presentation is a news story, the secondary content may include definitions of terms, biographies of involved parties, maps, or information about past or related events. For a television program or movie, the secondary content may include behind-the-scenes trivia, director or actor commentary, character biographies, or summaries of prior episodes or movies.

If the multimedia presentation includes a language other than the preferred language of the user, the secondary content may include a translation of the audio of the presentation (and/or of any foreign-language text appearing in the presentation). The translation may be human- or computer-generated and may be prepared prior to the broadcast of a pre-recorded presentation or created on-the-fly as the presentation is broadcast. For example, the secondary-content database 124 may include publicly available movie subtitles, and the content-processing module 116 may select subtitles corresponding to the temporal location. In another example, the multimedia presentation is a live performance of a foreign-language opera, and the content-processing module 116 identifies a native-language translation of the lyrics. In yet another example, the multimedia presentation is a popular song, and the secondary-content database 124 includes trivia about the song. In still another example, the multimedia presentation is a live foreign-language news broadcast, and the secondary-content database 124 includes an on-the-fly translation of the content of the broadcast.

The secondary content may include context-dependent advertising. For example, the secondary-content database 124 may include advertisements for products and/or services appearing in the multimedia presentation. In another embodiment, the secondary-content database 124 includes advertisements endorsed by the persons appearing in the multimedia presentation. The advertisements may also be based on the viewing history or expressed preferences of a user. In other embodiments, the advertisements are unrelated to the presentation or user.

Additional content unrelated to the multimedia presentation may be included with (or may make up) the secondary content. For example, a user may request that weather updates, email notifications, social media updates, financial information (e.g., stock quotes), or other information be included in the secondary content.

In one embodiment, the secondary-content database 124 includes a selection of commonly viewed television shows, movies, songs, and the like. The content-processing module 116 may anticipate the needs of users, however, by processing content from just-released movies, premiers of television shows, newly released songs, etc., as soon as that content becomes available. In one embodiment, the content-processing module 116 accesses the new content before it becomes available to the public via, for example, licensing agreements with content providers. No special agreement with a content source is required, however. In another embodiment, the content-processing module 116 determines an upcoming television schedule or subset thereof (e.g., prime-time shows for an upcoming week) and processes the content therein. The secondary-content database may include content specifically created for use therein, content added from publicly available Internet sites, and/or user-submitted content.

The secondary content is then delivered to the remote location (Step 308). The secondary content may be sent as audio, pictures, video, or any combination thereof. If different types of secondary content are to be transmitted (e.g., entertainment content and advertising content), the types may be combined before transmission. In such cases, an end user is unable to block out or ignore a particular type of secondary content. Accordingly, in alternative implementations (or as a user-selectable option), different types of secondary content are transmitted as separate packets or streams. No modification of the primary content of the multimedia presentation or of its signal is required in this case.

FIG. 4 illustrates a method 400 for feature extraction of a multimedia presentation. A pre-emphasis step 402 includes application of standard filters and normalization to increase performance and consistency during the remainder of the feature-extraction process 400. A window step 404 builds appropriately sized frames of samples in the digitized audio content. For example, a 44 kHz original audio signal may be processed into 20 ms frames, each consisting of approximately 880 audio samples. In addition, a windowing algorithm such as Hamming or Hanning may be applied. An energy step 406 includes feature extraction of components of the audio frames in the time domain, e.g., average power, energy deltas between frames, and high- or low-energy frame identification. The discrete-Fourier transform (“DFT”) 408, Mel-Filter Bank 410, and Inverse DFT 412 steps incorporate manipulations in the frequency domain to establish a set of features keyed to spectral analysis of the audio signal. These frequency-domain steps 408, 410, 412, may facilitate building time synchronization correlations. In a Deltas step 414, distinguishing features in each sample (e.g., high points of energy) may be used to further distinguish the sample in ways that are independent of other sample variables (e.g., the volume of the sample). The time-domain step 406 and frequency-domain steps 408, 410, 412 use features such as silence, power deltas, speaker change, voice/speech transitions, and other transitions in order to identify temporal characteristics (i.e., “fingerprints”) useful in establishing matches to feature database entries.

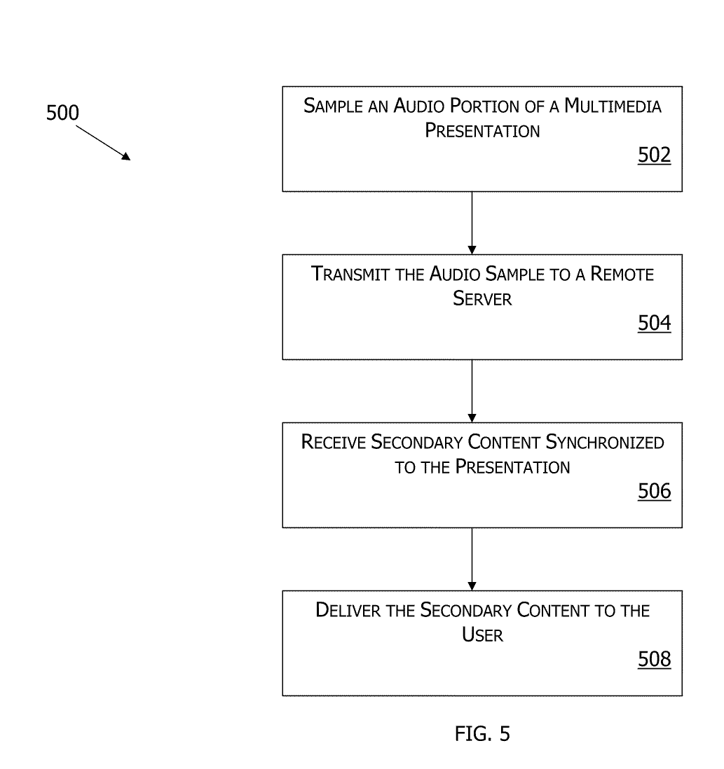

FIG. 5 illustrates a method 500 for delivering, to a user, secondary content synchronized to a multimedia presentation. In brief summary, an audio portion of the multimedia presentation is sampled (Step 502), and the sample is transmitted to a remote server (Step 504). Secondary content synchronized to the multimedia presentation is received in response (Step 506), and the secondary content is delivered to the user (Step 508).

In greater detail and with reference also to FIG. 1, in Step 502 the audio sample may be obtained by a local application 104 by capturing broadcast audio with a microphone, by tapping into an audio-signal output port of a multimedia presenter 102, or by tapping into a digital audio stream of the presenter 102. As described above, if the local application 104 is running on the same device as the multimedia presenter 102, the local application may sample the audio by intercepting a digital audio stream internal to the device. If the local application 104 is running on a device separate from the multimedia presenter 102, however, the internal digital audio stream may not be available, and the local application 104 may be limited to sampling the audio with a microphone or other audio input port available on its host device (e.g., a cellular phone). In one embodiment, the local application calibrates the microphone prior to sampling the audio of the multimedia presentation to, e.g., remove white noise, background noise, static, echoes, and the like.

The audio samples may be taken at periodic intervals appropriate for the multimedia presentation. For example, if the secondary content is delivered at a periodic interval, e.g., once every minute, it may be necessary to obtain audio samples only on a similar periodic interval. If, however, the secondary content is delivered as a continuous stream or without regular intervals, the audio samples may be taken continuously or on an ad-hoc basis prior to presenting any secondary content. In some cases, the user may manually start a sample/synchronization step. In general, more frequent samples may be taken at first to aid in identifying the multimedia presentation and/or the temporal location therein, and once the presentation and/or location have been so identified, the samples may be taken less frequently. Similarly, if the synchronization is lost (due to, e.g., the pausing of the multimedia presentation), the rate of sampling may increase until the presentation is re-synchronized.

The duration of the audio sample may be tunable, depending on application requirements. A longer sample may be easier to synchronize but may consume greater processing power and network bandwidth. In one embodiment, the sample duration increases when the remote server 110 is attempting to synchronize to the multimedia presentation and decreases when synchronization is achieved. The server 110 may send requests or commands to the local application 104 when and if a change in sample duration (or frequency, as described above) is desirable. In one embodiment, a user may specify a maximum sample frequency or sample duration. In another embodiment, the user may specify a maximum amount or percentage of resources the local application 104 is allowed to consume, and maximum sample frequency and duration are derived from this amount or percentage. The user may also specify a desired synchronization accuracy or maximum time to synchronize, from which the sample frequency and duration may also be derived.

The audio sample is transmitted to the remote server 110 (Step 504). The transmission may travel over the Internet via a wired or wireless network such as Ethernet, WiFi, a cellular-phone network, or any other network-transmission protocol. Depending on the power and processing capabilities of the local application 104, the audio samples may be pre-processed prior to transmission by the pre-process module 126. The pre-processing may include normalization and initial-feature extraction. Normalization may account for variances in environmental conditions and to ensure consistency in further processing stages. Initial-feature extraction may include some or all of the feature-extraction steps described with reference to FIG. 4.

The local application 104 receives secondary content synchronized to the multimedia presentation (506). In one embodiment, the secondary content is received over the same network 112 the audio sample was transmitted on. Based on the bandwidth of the network 112 and/or the processing power of the local application 104, the local application 104 may request more or less detail in the secondary content. For example, audio content having a greater or lesser sampling rate and/or video content having a greater or lesser frame rate may be requested. In the case of a very slow network 112, the local application 104 may request only text-based secondary content.

The secondary content is delivered to the user (Step 508). In one embodiment, a user interface 108 includes a display and the secondary content is displayed thereon. In another embodiment, the secondary content is audio and played back over a speaker or audio output in the user interface 108. The user may specify the type of preferred secondary content (e.g., audio, video, or both), as well as other parameters such as the rate of updates, preferred language, location, desired advertisements, etc. This information, as well as other information, may be captured in a user profile or user account, allowing the user to set preferences for use with subsequent multimedia presentations. In one embodiment, the user account may be accessed and edited from a web browser running on any computing devices.

In one embodiment, multiple local applications 104 may be used with the same multimedia presenter 102 and, based on different user preferences, the secondary content delivered to each local application 104 may be customized for each user. The secondary content may also differ based on the type of delivery device; e.g., graphical and/or video data may be optimized for viewing on the smaller screen of a cellular phone or on the larger screen of a notebook computer.

The user interface 108 may further include a means of accepting user input, such as a keyboard, mouse, touchscreen, speech-to-text system, trackball, or the like. This user input device may be used to change user preferences, as described above, or to chat with other users. In one embodiment, the user interface 108 may be used to communicate with an interactive multimedia presentation (e.g., a game show). In another embodiment, users may add content to the secondary content database 124 using the user interface 108. Other users may opt to view or ignore the user-generated content, instead relying on the officially generated content.

In various embodiments, the user-generated content is social content and/or comments from other users communicated via the user interface 108, Internet (e.g., social media web sites, IRC chat, or messaging), or cellular networks (e.g., SMS text messaging). The user-generated content may be captured and stamped with a time index corresponding to their creation time within the multimedia presentation. A user may view/hear the secondary content as it is being created (i.e., live) by other users or may view/hear secondary content created during a previous viewing of the multimedia presentation. The previously created secondary content may be stored in the content database 124 for later use. For example, a comment referring to a character appearing in a particular episode of a TV show at minute 14.38 may be played back as secondary content three years later during viewing of a DVD copy of that episode.

In one embodiment, the local database 128 on the local application 104 includes audio features and/or secondary content relevant to a viewed multimedia presentation. The audio features and secondary content may be generated by the audio processing server 114 and content processing server 116, respectively, and transmitted to the local database 128 via the network 112 prior to viewing the multimedia presentation. A user may select a particular multimedia presentation for which information should be downloaded to the local database 128, or information may be automatically downloaded based on, e.g., user preferences or viewing habits. In one embodiment, during playback of the multimedia presentation, the pre-process module 126 of the local application 104 performs audio processing and feature extraction of an audio sample and compares the extracted features to the audio features stored in the local database 128. If a matching feature is found, the local application 104 may fetch appropriate secondary content from the local database 128 and display it on the user interface 108. In this embodiment, once the audio features and/or secondary content have been downloaded to the local database 128, the network connection 112 is no longer needed to synchronize and display the secondary content. This embodiment may be used when, for example, the network connection 112 is unavailable during the multimedia presentation (in, for example, a cinema lacking wireless Internet access). In another embodiment, the remote server 110 and/or remote database 118 transmit the audio features and/or secondary content to the local database 128 during playback of the multimedia presentation (in response to, for example, a surge in network traffic or server load), thereby off-loading processing to the local application 104 in order to provide seamless playback of the secondary content.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method for providing secondary content synchronized to a remotely-experienced multimedia presentation, the method comprising:
receiving, from a remote location, an audio sample of the multimedia presentation;
determining a temporal location, within the multimedia presentation, of the audio sample;
identifying secondary content based on the temporal location; and
causing delivery of the secondary content to the remote location, the secondary content being synchronized to the multimedia presentation.

2. The method of claim 1, further comprising identifying the multimedia presentation based at least in part on the audio sample.

3. The method of claim 2, wherein identifying the multimedia presentation comprises comparing the audio sample to a database of audio features.

4. The method of claim 1, wherein the audio sample is received from a device located where the multimedia presentation is experienced.

5. The method of claim 1, wherein the temporal location is determined based on an analysis of the audio sample.

6. The method of claim 1, wherein the multimedia presentation comprises a live TV program.

7. The method of claim 1, wherein the multimedia presentation comprises a time-shifted TV program.

8. The method of claim 1, further comprising analyzing the multimedia presentation, prior to the step of determining the temporal location, to facilitate locating of the audio sample within the multimedia presentation.

9. The method of claim 8, further comprising storing results of the analysis of the multimedia presentation in an audio features database.

10. The method of claim 8, wherein analyzing the multimedia presentation comprises at least one of feature extraction and indexing.

11. The method of claim 10, wherein feature extraction comprises at least one of pre-emphasizing audio content of the multimedia presentation, creating frames of samples of audio content of the multimedia presentation, extracting features of audio content of the multimedia presentation in a time domain, or extracting features of audio content of the multimedia presentation in a frequency domain.

12. The method of claim 1, wherein determining the temporal location comprises matching a pattern in the audio sample with a pattern in the multimedia presentation.

13. The method of claim 1, wherein the audio sample is received at a periodic interval, on an ad-hoc basis, or at a request from a user.

14. The method of claim 1, wherein identifying secondary content comprises querying a database of secondary content with the temporal location.

15. The method of claim 1, wherein the secondary content comprises at least one of live user-generated content and stored user-generated content.

16. A system for providing secondary content synchronized to a multimedia presentation, the system comprising:
computer memory for storing an audio sample of the multimedia presentation;
an audio-processing module for determining a temporal location, within the multimedia presentation, of the audio sample;
a content-processing module for identifying secondary content based on the temporal location; and
a transmitter for transmitting the secondary content to a remote location, the secondary content being synchronized to the multimedia presentation.

17. The system of claim 16, wherein the audio-processing module comprises at least one of a feature-extractor module or a time-indexing module.

18. The system of claim 17, wherein the feature-extractor module comprises at least one of a pre-emphasis filter, a window frame-builder module, a time-domain feature extractor, or a frequency-domain feature extractor.

19. The system of claim 16, further comprising a secondary-content server for hosting a database of secondary content, the database serving secondary content based on the determined temporal location.

20. The system of claim 16, wherein the interface module is hosted on at least one of a notebook computer, netbook computer, desktop computer, personal digital assistant, cellular phone, or handheld media player.

21. The system of claim 16, wherein the secondary content comprises at least one of live user-generated content and stored user-generated content.

22. A method for delivering secondary content synchronized to a multimedia presentation to a user, the method comprising:
sampling an audio portion of the multimedia presentation, thereby creating an audio sample;
transmitting the audio sample to a remote server;
receiving secondary content synchronized to the multimedia presentation, the secondary content based at least in part on the temporal location of the audio sample in the multimedia presentation;
delivering, via a user interface, the secondary content to the user.

23. The method of claim 22, wherein delivering the secondary content comprises one of displaying visual data or playing back audio data.

24. The method of claim 22, further comprising pre-processing the audio sample prior to transmission.

25. The method of claim 23, wherein pre-processing the audio sample comprises at least one of normalization or initial-feature extraction.

26. The method of claim 22, wherein the secondary content is delivered based at least in part on a user preference, a location of the user interface, or a screen size of the user interface.

27. The method of claim 22, further comprising varying the length of the audio sample.

28. The method of claim 22, wherein the secondary content comprises at least one of live user-generated content and stored user-generated content.

29. An article of manufacture comprising computer-readable instructions thereon for delivering secondary content to a user, the secondary content synchronized to a multimedia presentation, the article of manufacture comprising:
instructions to sample an audio portion of the multimedia presentation, thereby creating an audio sample;
instructions to transmit the audio sample to a remote server;
instructions to receive secondary content synchronized to the multimedia presentation, the secondary content based at least in part on the temporal location of the audio sample in the multimedia presentation;
instructions to deliver the secondary content to the user.

30. The article of claim 29, wherein delivering the secondary content comprises one of displaying visual data or playing back audio data.

31. The article of claim 29, further comprising instructions for pre-processing the audio sample prior to transmission.

32. The article of claim 31, wherein pre-processing the audio sample comprises at least one of normalization or initial-feature extraction.

33. The article of claim 29, wherein the secondary content is delivered based at least in part on a user preference, a location of the user interface, or a screen size of the user interface.

34. The article of claim 29, further comprising instructions for varying the length of the audio sample.

35. The method of claim 29, wherein the secondary content comprises at least one of live user-generated content and stored user-generated content.

36. A method for delivering secondary content synchronized to a multimedia presentation to a user, the method comprising:
sampling an audio portion of the multimedia presentation, thereby creating an audio sample;
determining a temporal location, within the multimedia presentation, of the audio sample;
identifying secondary content based on the temporal location; and
delivering, via a user interface, the secondary content to the user.

37. The method of claim 36, further comprising:
receiving, from a remote location, at least one of audio features corresponding to the multimedia presentation and secondary content corresponding to the multimedia presentation; and
storing at least one of the audio features and secondary content in a local database.

38. A system for providing secondary content synchronized to a multimedia presentation, the system comprising:
computer memory for storing an audio sample of the multimedia presentation;
a pre-process module for determining a temporal location, within the multimedia presentation, of the audio sample; and
a user interface for delivering secondary content corresponding to the temporal location to a user.

39. The system of claim 38, further comprising a local database for storing the secondary content.
